(19) United States
(12) Patent Application Publication
(10) Pub. No.: US 2004/0051280 A1
(43) Pub. Date: Mar. 18, 2004

(54) Air bag door

(75) Inventors: Gabriel Anaya, Shelby Township, MI (US); Paul T. Saccone, Rochester Hills, MI (US)

Correspondence Address: TAROLLI, SUNDHEIM, COVELL & TUMMINO L.L.P., 526 SUPERIOR AVENUE, SUITE 1111, CLEVEVLAND, OH, 44114, US

(73) Assignee: TRW Vehicle Safety Systems Inc.

(21) Appl. No.: 10/242,819

(22) Filed: Sep. 13, 2002

(51) Int. Cl. B60R 21/20

(52) U.S. Cl. 280/728.3

(57) ABSTRACT

An apparatus (10) includes a molded portion (60) associated with an inflatable vehicle occupant protection device (14). The molded portion (60) is molded as a single piece of plastic material. The molded portion includes a base portion (64) and a reinforcing portion (100). The base portion has a first thickness measured between a first class A surface (42) and an opposite second surface (80). The reinforcing portion (100) includes a main wall portion (126) spaced from the second surface and at least one side wall (110, 112, 114, 116) extending from the main wall portion, merging with the second surface, and having a second thickness about equal to the first thickness. The main wall portion (126), base portion (64), and at least one side wall (110, 112, 114, 116) define a chamber (170) in the molded portion.

### FIELD OF THE INVENTION

The present invention relates to an air bag door for helping to enclose an air bag in a vehicle.

### BACKGROUND OF THE INVENTION

It is known to provide an inflatable vehicle occupant protection device, such as an air bag, for helping to protect an occupant of a vehicle. One particular type of air bag is a front impact air bag inflatable between an occupant of a front seat of the vehicle and an instrument panel of the vehicle. Such air bags may be driver side air bags or passenger side air bags. When inflated, the air bags help protect the occupant from impacts with parts of the vehicle, such as the instrument panel.

Passenger side air bags are typically stored in a deflated condition in a housing that is mounted in the vehicle instrument panel. An air bag door is connectable to the housing and/or instrument panel to help conceal and enclose the air bag in a stored condition. The air bag door has a surface that forms a portion of a surface of the instrument panel that is visible to vehicle occupants. These visible surfaces are sometimes referred to as “class A” surfaces of the vehicle. Since the class A surface is visible to vehicle occupants, it is desirable for the class A surface of the air bag door to have an attractive aesthetic appearance.

Upon deployment of the passenger side air bag, the air bag door opens to permit the air bag to move to an inflated position. The air bag door opens as a result of forces exerted on the door by the inflating air bag. In order to help prevent injury to the vehicle occupant, the air bag door is structurally reinforced so that the door does not break apart or fragment during deployment of the air bag. The air bag door may also be connected to the instrument panel by means, such as a hinge or strap, so that the door is retained near the instrument panel during air bag deployment.

Known air bag doors have a multi-piece construction including a base or frame structure constructed of a high strength material, such as metal. A layer of foam material is fixed to the base by means such as molding the foam around the base. The foam material is then coated with a layer of skin material, such as vinyl, which forms the class A surface of the air bag door. The frame structure helps provide the requisite strength for withstanding deployment of the air bag.

### SUMMARY OF THE INVENTION

The present invention relates to an apparatus for helping to protect an occupant of a vehicle. The apparatus includes an inflatable vehicle occupant protection device inflatable from a stored position to an inflated position. The apparatus also includes an inflation fluid source that is actuatable to provide inflation fluid for inflating the inflatable vehicle occupant protection device. The apparatus further includes a molded portion molded as a single piece of plastic material and associated with the inflatable vehicle occupant protection device. The molded portion includes a base portion and a reinforcing portion. The base portion has a first surface, an opposite second surface, and a first thickness measured between the first and second surfaces. The first surface forms a class A surface in the vehicle. The reinforcing portion includes a main wall portion spaced from the second surface and at least one side wall extending from the main wall portion to the second surface and merging with the second surface. The at least one side wall has a second thickness about equal to the first thickness. The main wall portion, base portion, and at least one side wall define a chamber in the molded portion.

The present invention also relates to an apparatus that that includes an inflatable vehicle occupant protection device inflatable from a stored position to an inflated position. An inflation fluid source provides inflation fluid for inflating the protection device. A door helps to enclose the protection device in the stored position. The door includes a molded portion molded as a single piece of plastic material, a bracket at least partially embedded in the molded portion, and a tether secured to the bracket for connecting the door to the vehicle. The molded portion includes a base portion and a reinforcing portion. The base portion has a first surface and a second surface opposite the first surface. The first surface forms a class A surface in the vehicle. The base portion has a first thickness measured between the first and second surfaces. The reinforcing portion includes a main wall portion spaced from the second surface and at least one side wall extending from the main wall portion to the second surface and merging with the second surface. The at least one side wall has a second thickness about equal to the first thickness. The main wall portion, base portion, and the at least one side wall define a chamber in the door.

The present invention also relates to a door for helping to enclose an air bag in a vehicle. The door includes a molded portion and a bracket at least partially embedded in the molded portion. The molded portion includes a base portion and a reinforcing portion. The base portion has a first thickness measured between a first class A surface and an opposite second surface of the base portion. The reinforcing portion includes a main wall portion spaced from the second surface and at least one side wall extending from the main wall portion, merging with the second surface, and having a second thickness about equal to the first thickness. The main wall portion, base portion, and at least one side wall define a chamber that receives a pressurized gas during molding of the door. The pressurized gas exerts a force on the main wall, base portion, and at least one side wall during cooling of the plastic material.

The present invention further relates to a method for producing an air bag door for helping to enclose an air bag in a stored position in a vehicle. The method includes the step of providing a mold including a first mold piece and a second mold piece, the mold having a closed condition in which a mold cavity is defined between the first and second mold pieces. The method also includes the steps of placing a metal bracket in the mold cavity, placing the mold in the closed condition, and injecting a molten plastic material into the mold cavity to fill the mold cavity at least partially. The molten plastic material forms a molded portion of the air bag door in the mold cavity that at least partially surrounds the bracket. The molded portion includes a base portion having a first surface, a second surface opposite the first surface, and a first thickness measured between the first and second surfaces. The molded portion further includes at least one side wall for reinforcing the air bag door and supporting the bracket. The at least one side wall extends transverse to the base portion, merges with the second surface, and has a second thickness about equal to the first thickness. The method further includes the step of injecting a pressurized gas into the mold cavity. The gas when injected into the mold cavity helps form a chamber of the air bag door, the chamber being bounded by the at least one side wall, the second surface, and a portion of the molded portion overlying the bracket. The pressurized gas pressurizes the chamber and exerts a force on the main wall portion, the base portion, and the at least one side wall during cooling of the plastic material.

### BRIEF DESCRIPTION OF THE DRAWINGS

The foregoing and other features of the present invention will become apparent to one skilled in the art to which the present invention relates upon consideration of the following description of the invention with reference to the accompanying drawings, in which:

FIG. 1 is a schematic illustration of a vehicle including an air bag in a stored condition enclosed by an air bag door constructed in accordance with an illustrated embodiment of the present invention;

FIG. 2 is a schematic illustration of the vehicle of FIG. 1, illustrating the air bag in a deployed condition;

FIG. 3 is a rear plan view of the air bag door of FIGS. 1 and 2;

FIG. 4 is a sectional view taken generally along line 4-4 in FIG. 3;

FIG. 5 is a sectional view taken generally along line 5-5 in FIG. 3;

FIG. 6 is a sectional view taken generally along line 6-6 in FIG. 3;

FIG. 7 is a sectional view taken generally along line 7-7 in FIG. 3;

FIG. 8 is a sectional view taken generally along line 8-8 in FIG. 3;

FIG. 9 is a side plan view of a portion of a known molded plastic structure; and

FIG. 10 is a schematic representation of a mold used to construct a portion of the air bag door of FIGS. 1-8.

### DESCRIPTION OF THE PREFERRED EMBODIMENTS

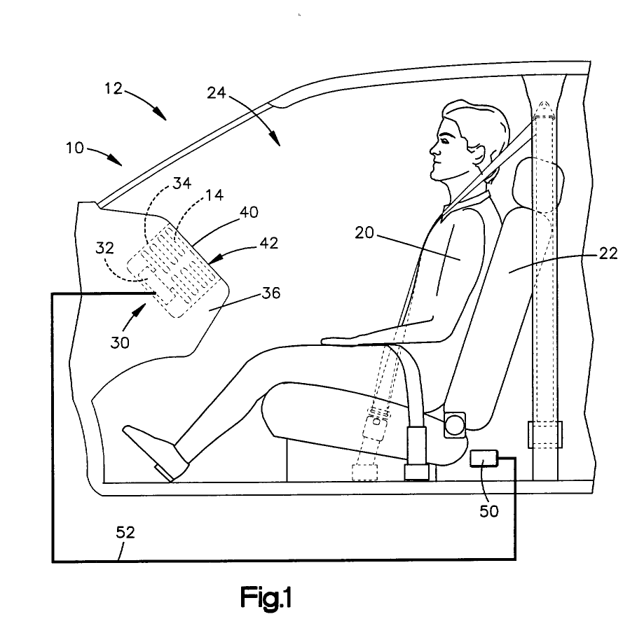

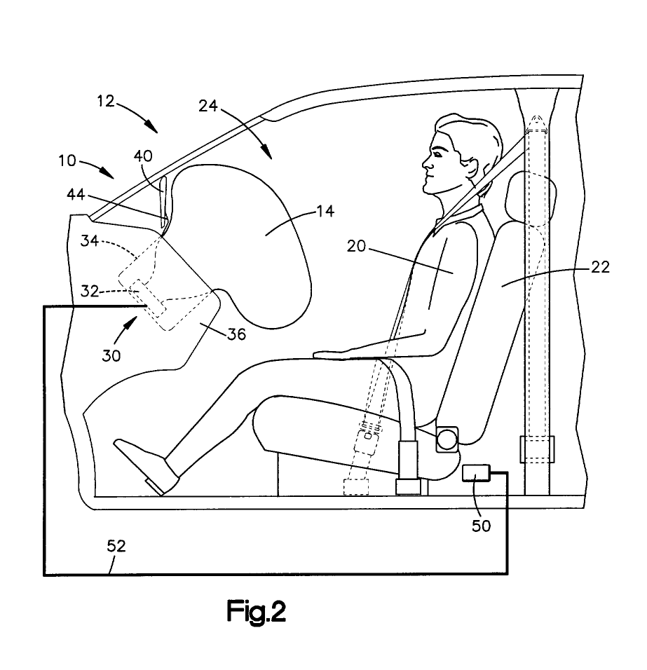

The present invention relates to an inflatable vehicle occupant protection device for helping to protect an occupant of a vehicle. More particularly, the present invention relates to an apparatus for helping to enclose an air bag in a vehicle. As illustrated in FIGS. 1 and 2, the apparatus 10 comprises an air bag door 40 for helping to enclose an air bag 14 in a vehicle 12. In the illustrated embodiment, the air bag 14 is a passenger side front impact air bag for helping to protect an occupant 20 in a passenger side 24 of the vehicle 12. In the illustrated embodiment, the occupant 20 is positioned in a seat 22 in the passenger side 24 of the vehicle 12.

As illustrated in FIGS. 1 and 2, the air bag 14 may be part of an air bag module 30 that includes an inflator 32 and a housing 34. The air bag 14 has a stored condition in which the air bag is folded and placed in the housing 34. The housing 34 and thus the module 30 is connected to an instrument panel 36 of the vehicle 12 on the passenger side 24 of the vehicle. The housing 34 helps contain and support the air bag 14 and inflator 24 in the instrument panel 36.

The air bag door 40 is releasably connected to the instrument panel 36 and/or the housing 34. The air bag door 40 forms a cover for the module 30 and helps enclose the air bag 14 in the stored condition in the housing 34. An outer surface (FIG. 1) of the air bag door 40 forms a class A surface 42 of the instrument panel 36 that is visible to passengers 20 of the vehicle 12.

The inflator 32 (FIGS. 1 and 2) is actuatable to provide inflation fluid for inflating the air bag 14. The inflator 32 may be of any known type, such as stored gas, solid propellant, augmented, and hybrid. The apparatus 10 includes a sensor, illustrated schematically at 50, for sensing an event for which occupant protection is desired, such as a collision. The inflator 32 is operatively connected to the sensor 50 via lead wires 52.

Upon sensing the occurrence of an event for which occupant protection is desired, the sensor 50 provides a signal to the inflator 32 via the lead wires 52. Upon receiving the signal from the sensor 50, the inflator 32 is actuated in a known manner and provides inflation fluid to the air bag 14. The air bag 14 inflates from the stored condition of FIG. 1 to a deployed condition illustrated in FIG. 2. The air bag 14, while inflated, helps protect the vehicle occupant 20 from impacts with parts of the vehicle 12, such as the instrument panel 36.

As the air bag 14 inflates, the inflating air bag exerts a force on the air bag door 40. This force causes the door 40 to disengage from the instrument panel 36 and/or housing 34, which allows the air bag 14 to inflate from the stored position (FIG. 1) to the deployed position of FIG. 2. The module 30 also includes means, such as a tether 44, for connecting the door 40 to the instrument panel 36 and/or housing 34. The tether 44 helps retain the door 40 near the instrument panel 36 when the air bag 14 is deployed. This helps prevent the air bag door 40 from hitting or otherwise contacting the occupant 20 when the air bag 14 is deployed.

Referring to FIGS. 3-8, the air bag door 40 includes a molded portion 60 and a bracket 62. The molded portion 60 supports the bracket 62 in the illustrated position relative to the molded portion. The molded portion 60 is constructed of an elastomeric material, such as plastic. Examples of such plastic materials are polyvinyl chloride (PVC), thermoplastic elastomers (TPE) such as polypropylene and polypropylene copolymers, thermoplastic polyolefin elastomers (TPO) such as polypropylene and ethylene propylene diene monomers (EPDM), thermoplastic elastomers based on polyether esters and polyester esters (TPEE), copolyester (TEEE), thermoplastic vulcanizates (RPV), rubber modified polypropylene (EMPP), and PA6/PA66 nylon. Other suitable elastomeric materials may also be used.

The bracket 62 is constructed of a generally strong and rigid material, such as steel. The molded portion 60 is molded around the bracket by means such as insert molding. In this instance, the bracket 62 is placed in a mold and molten plastic material, referred to as “melt”, is injected into the mold. The melt at least partially fills the mold cavity and at least partially surrounds the bracket 62, forming the molded portion 60. The bracket 62 is thus at least partially embedded in the molded portion 60. The molded portion 60 forms a single piece of material that at least partially surrounds the bracket 62 and supports the bracket in the air bag door 40.

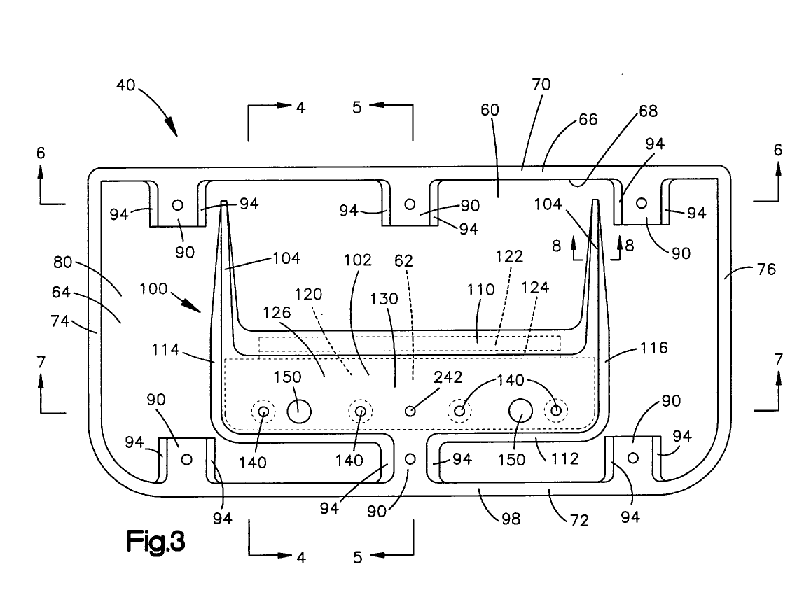

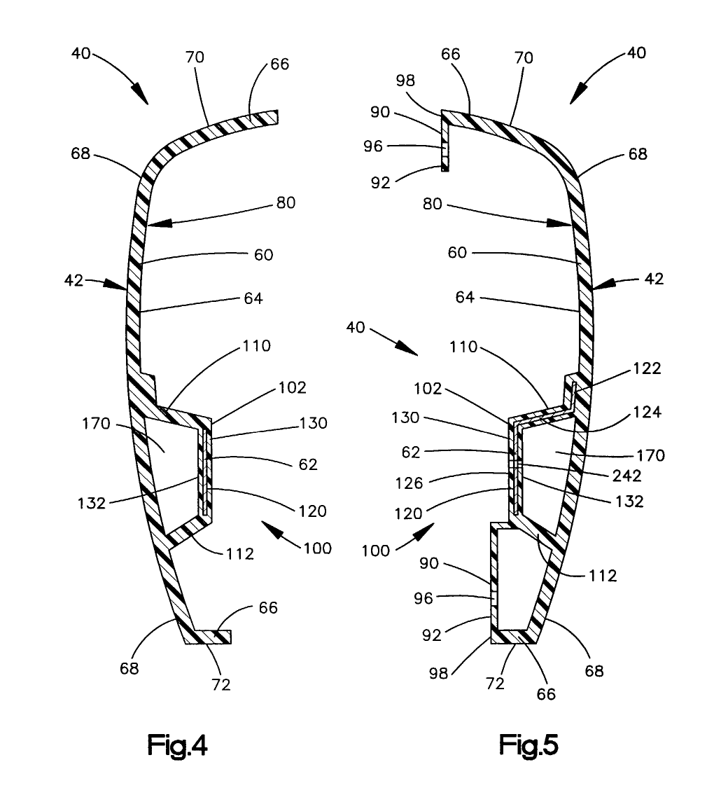

In the illustrated embodiment, the air bag door 40 has a generally rectangular configuration. It will be appreciated, however, that the door 40 may have any desired shape depending on a variety of factors, such as the shape or configuration of the structure (e.g., the instrument panel 36) in which the door is implemented. The molded portion 60 of the air bag door 40 includes a base portion 64 and a rim portion 66 that extends transverse to the base portion along a periphery 68 of the base portion. The base portion 64 has a generally planar configuration and may be slightly curved as shown in FIGS. 4 and 5. One surface of the base portion 64 forms the class A surface 42 of the air bag door 40. The base portion 64 includes an inner surface 80 opposite the class A surface 42.

The rim portion 66 includes an upper side wall 70, an opposite lower side wall 72 and spaced end walls 74 and 76 of the air bag door 40. As viewed in FIG. 3, the air bag door 40 has a length measured in a direction parallel to the upper and lower side walls 70 and 72 from the end wall 74 to the end wall 76. The air bag door 40 also has a width measured in a direction perpendicular to the length and parallel to the end walls 74 and 76 from the upper side wall 70 to the lower side wall 72. In the illustrated embodiment, the rim portion 66 extends along the entire periphery 68 of the base portion 64. The rim portion 66 could, however, extend along a portion or selected portions of the periphery 68.

The air bag door 40 also includes a plurality of fastener support portions 90 molded integrally with the molded portion 60 of the door. In the illustrated embodiment, the air bag door 40 includes six fastener support portions 90. The support portions 90 are spaced along the upper side wall 70 and lower side wall 72 and merge with the rim portion 66. It will be appreciated, however, that the number and positioning of the support portions 90 may vary.

Referring to FIGS. 3, 5, and 6, each support portion 90 includes a planar, generally rectangular, main portion 92 that merges with a terminal edge 98 of the rim portion 66 and extends transverse to the rim portion. A pair of support legs 94 extend from opposite edges of the main portion 92 and diverge from each other at an acute angle relative to the main portion. The support legs 94 merge with the inner surface 80 of the base portion 64. The support legs 94 may also merge with the rim portion 66, as best shown in FIG. 3.

Each support portion 90 also includes an aperture 96 that extends through the main portion 92. The apertures 96 are adapted to receive means (not shown) for releasably connecting the air bag door 40 to the vehicle 12, i.e., to the housing 34 and/or instrument panel 36 (see FIGS. 1 and 2). Such means may include, for example, fasteners or pins extendable through the aperture 96 to connect the door 40 to the vehicle 12.

Referring to FIGS. 3-5 and 7, a reinforcing portion 100 of the air bag door 40 is positioned within the periphery 68 of the base portion 64. The reinforcing portion 100 helps bolster the structural integrity of the air bag door 40 so that the door may withstand forces experienced during deployment of the air bag 14. The reinforcing portion 100 also helps provide means by which to connect the air bag door 40 to the vehicle 12 via the tether 44.

As shown in FIGS. 3-5 and 7, the reinforcing portion 100 comprises a portion of the molded portion 60 that projects from the inner surface 80 of the base portion 64. The reinforcing portion 100 is molded around the bracket 62 and thus connects the bracket to the door 40. The reinforcing portion 100 includes a main portion 102 and a pair of ribs 104 that extend from the main portion.

The main portion 102 includes spaced first and second side walls 110 and 112, respectively, that extend parallel to the length of the air bag door 40. The main portion 102 also includes third and fourth side walls 114 and 116, respectively, that extend transverse to the first and second side walls 110 and 112 in a direction parallel to the width of the air bag door 40. The third and fourth side walls 114 and 116 intersect the second side wall 112 and extend toward the first side wall 110. One of the ribs 104 merges with the first and third side walls 110 and 114. The other rib 104 merges with the first and fourth side walls 110 and 116.

Referring to FIGS. 3 and 5, the bracket 62 has a bent configuration and includes a main portion 120, a flange portion 122, and an angled portion 124 that extends between the main portion and flange portion. The main portion 120 is spaced from the inner surface 80 of the base portion 64. The flange portion 122 engages and overlies the inner surface 80 of the base portion 64. The bracket 62 is sandwiched between layers 130 and 132 of the reinforcing portion 100. The layers 130 and 132 follow the contour of the main portion 120, flange portion 122, and angled portion 124.

The portions of the layers 130 and 132 extending along the main portion 120 of the bracket 62 form a main wall 126 of the reinforcing portion 100. The portions of the layers 130 and 132 extending along the flange portion 122 and angled portion 124 help define the first side wall 110 of the reinforcing portion 100. The side walls 110, 112, 114, and 116 extend from peripheral edges of the main wall 126 to the base portion 64 and merge with the inner surface 80 of the base portion. As shown in FIG. 3, one of the support portions 90 positioned centrally along the lower edge 72 merges with the main wall 126 and the second side wall 112 of the reinforcing portion 100.

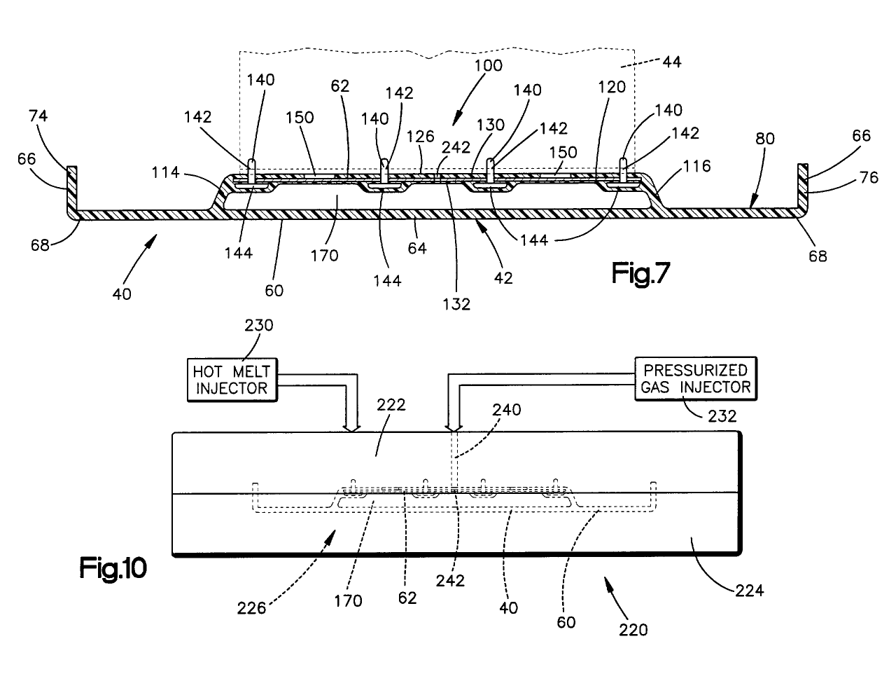

Referring to FIG. 7, the bracket 62 includes means for connecting the tether 44 to the air bag door 40. In the illustrated embodiment, the bracket 62 includes a plurality of studs 140 that extend from the main portion 120 through the layer 130 of the reinforcing portion 100. It will be appreciated, however, that the bracket 62 may include various alternative means for connecting the air bag door 40 to the tether 44.

Each stud 140 has a shaft portion 142 that extends through the main portion 120 of the bracket 62. A head portion 144 of each stud engages the main portion 120 and is positioned between the main portion and the layer 132 of the reinforcing portion 100. As shown in FIG. 7, the layer 132 may be contoured around the head portions 144 of the studs 140. The studs 140 are connected to the main portion 120 by known means, such as welding, adhesives, and mechanical clinch fit.

The tether 44 is constructed of a flexible material, such as fabric, so as to permit movement of the air bag door 40 during deployment of the air bag 14. Alternative materials, such as elastomers, could also be used to construct the tether 44. In the embodiment illustrated in FIG. 7, a single tether 44 is connected to all four studs 140. It will be appreciated, however, that multiple tethers (not shown) could be used to connect the air bag door 40 to the vehicle. For example, four separate tethers could be connected individually to respective ones of the four studs 140.

The reinforcing portion 100 includes a pair of apertures 150 that extend through the layer 130 and expose the main portion 120 of the bracket 62. The apertures 150 provide access to the bracket 62 to help position the bracket while molding the molded portion 60 around the bracket. The location and number of apertures 150 may vary.

Referring to FIG. 8, each rib 104 includes a pair of opposing side walls 160 that merge with the inner surface 80 of the base portion 64. The side walls 160 extend at acute angles from the inner surface 80 and converge towards each other. The side walls 160 meet at an intersection 162 spaced from the inner surface 80. The ribs 104 help reinforce the air bag door 40 to help provide the door with a desired strength and rigidity. This helps the air bag door 40 withstand forces associated with air bag deployment.

Referring to FIGS. 4, 5, and 7, the air bag door 40 includes a chamber 170 positioned between the base portion 64 and the reinforcing portion 100. The chamber 170 is defined by the spaced base portion 64 and main wall 126, and by the first, second, third and fourth side walls 110, 112, 114, and 116, which extend from the base portion to the main wall. The chamber 170 thus has a generally rectangular configuration as viewed in the plan view of FIG. 3. The chamber 170 could, however, have an alternative configuration depending on factors such as the size or shape of the reinforcing portion 100 and/or the air bag door 40.

Those skilled in the art will appreciate that, when providing a molded vehicle part that forms a class A surface in the vehicle, it is desirable that the class A surface have an attractive aesthetic appearance. One particular problem known in the field of providing molded vehicle parts is referred to as sink marks. This problem is illustrated by way of example in FIG. 9.

Referring to FIG. 9, a vehicle part 200 constructed of a molded plastic material has a nominal wall 202 and a projection 204, such as a rib. In this example, the nominal wall 202 forms a class A surface 206. As illustrated in FIG. 9, the thickness of the nominal wall 202 and the thickness of the projection 204 are about equal to each other. As a result, a sink mark 210 is formed in the class A surface 202 during molding of the part 200. The sink mark 210 is formed on the class A surface 202 opposite the intersection of the nominal wall 202 and the projection 204. The sink mark 210, being located on the class A surface 202, would thus be visible to a vehicle occupant and would thus be considered an undesirable aesthetic defect in the class A surface 202.

The sink mark 210 occurs because the intersecting nominal wall 202 and projection 204 form a section of material, indicated generally at 212, that has a large cross-sectional area relative to the thickness of the nominal wall. When the hot melt is injected into the mold, the section 212, having a large area relative to surrounding portions (i.e., the nominal wall 202 and the projection 204) of the part 200, cools at a slower rate than the surrounding portions. The surrounding portions also help insulate the section 212, which further slows the cooling rate of the section. Thus, as the section 212 cools, it shrinks at a different rate than the surrounding portions. This difference in cooling rates causes the section 212 to draw inward and create the sink mark 210 on the class A surface 206 the part 200.

In order to help eliminate sink marks in molded plastic parts, it is known to limit the thickness of projections from the nominal wall to help reduce the cross-sectional area at the intersection of the nominal wall and the projection. For example, a general rule for preventing sink marks is to limit the thickness of projections to about 50% to 60% of the thickness of the nominal wall. This rule may vary depending on the particular type of material. For example, high shrinkage materials (e.g., nylon, polypropylene) are prone to sink marks and thus may require a lower projection thickness. Low shrinkage materials (e.g., polycarbonate, polystyrene) may withstand a higher projection thickness without producing sink marks. The example materials cited above (PVC, TPE, TPO, EPDM, TPEE, TEEE, RPV, EMPP, and PA6/PA66 nylon) adhere to the general 50% to 60% rule.

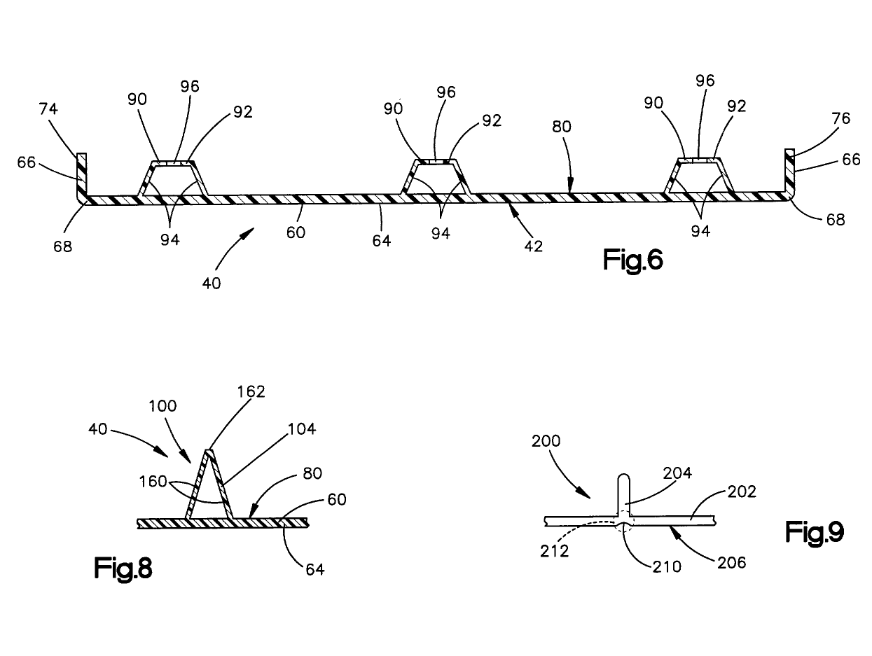

The general rule stated above may be implemented in portions of the illustrated embodiment of the present invention. For example, the support walls 94 of the support portions 90 and the side walls 160 of the ribs 104 (see FIGS. 6 and 8) comprise projections from the nominal wall, i.e., the base portion 64 of the air bag door 40. It will be appreciated that the support walls 94 and the side walls 160 each have a thickness of about 50% to 60% of the thickness of the base portion 64, as dictated by the general rule. This helps to prevent sink marks on the class A surface 42 of the air bag door 40 opposite the support walls 94 and side walls 106.

As a feature of the present invention, the air bag door 40 is constructed of a plastic material using a gas assisted molding technique. The gas assisted molding technique allows the projection thickness dictated by the general rule to be increased without producing sink marks. According to the present invention, the air bag door 40 is constructed via a gas assisted injection molding process in which the molded portion 60 is molded around the bracket 62 to support the bracket. This is commonly referred to as insert molding. A gas assisted insert molding process used to produce the air bag door 40 of the present invention is described herein with reference to FIG. 10.

Referring to FIG. 10, a mold 220 for producing the air bag door 40 includes first and second mold pieces 222 and 224, respectively. In a closed position of the mold 220 illustrated in FIG. 10, a mold cavity 226 is formed between the first and second mold pieces 222 and 224. The bracket 62 is placed in the mold cavity 226, and the mold 220 is placed in the closed position. A hot melt injector, illustrated schematically at 230, injects hot melted plastic material (“melt”) into the mold cavity 226 through a machine nozzle (not shown) in a known manner. The melt surrounds the bracket 62 and is formed in the shape of the molded portion 60 of the air bag door 40. Prior to opening the mold and before the hot melt solidifies, a pressurized gas injector, illustrated schematically at 232, injects a pressurized gas, such as nitrogen, into the mold cavity 226.

The mold 220 includes a gas conduit, illustrated schematically at 240, through which the gas injector 232 injects the gas into the mold cavity 226. The gas conduit 240 may comprise any known means for delivering the pressurized gas to the mold cavity 226. For example, the gas conduit 240 may comprise the machine nozzle through which the hot melt material is injected into the mold cavity 226. Alternatively, the gas conduit 240 may comprise a gas needle, separate from the machine nozzle. Although the mold 220 is illustrated in FIG. 10 as having a single, centrally located gas conduit 240, it will be appreciated that the mold 220 may include a plurality of gas conduits spaced about the mold.

Referring to FIGS. 3, 5, 7, and 10, the air bag door 40 includes a gas injection aperture 242 through which the pressurized gas is injected. The gas injection aperture 242 is in fluid communication with the chamber 170. In the illustrated embodiment, the gas injection aperture 242 extends through the main portion 120 of the bracket 62. Those skilled in the art will appreciate, however, that the gas injection aperture 242 may have a different position on the air bag door 40 and that the air bag door may include more than one gas injection aperture.

The pressurized gas is injected into the mold cavity 226 while the hot melt is still molten. When injected, the pressurized gas takes the path of least resistance in the mold cavity 226. Thus, the pressurized gas may tend to flow into areas of the mold cavity in which the hot melt has a low pressure and/or high temperature. The pressurized gas displaces thicker sections of the hot melt, which helps distribute the hot melt in the mold cavity 226. The pressurized gas thus helps to form the walls of the chamber 170 and the ribs 104 of the air bag door 40.

The gas also pressurizes the chamber 170 (FIGS. 3-5 and 7) and exerts a pressure on the hot melt as the hot melt cools. More specifically, the pressurized gas exerts a pressure on the layer 132, on the base portion 64, and on the first, second, third, and fourth side walls 110, 112, 114, and 116. At intersections between the nominal wall and the projections that are exposed to the gas pressure, i.e., at the intersection of the base portion 64 and the side walls 110, 112, 114, and 116, the pressure of the gas exerts a force on the hot melt in directions that oppose the “drawing in” of the melt in the direction in which the sinking occurs. This helps prevent the formation of sink marks. Thus, at intersections exposed to the gas pressure, the projection thickness may be increased without producing sink marks.

After the hot melt solidifies and/or cools to a predetermined point, the mold 220 is opened, and the pressurized gas is released. At this point, the air bag door 40 may be removed from the mold 220. The air bag door 40, having been constructed in accordance with the procedure outlined above, has a construction in which projections (i.e., side walls 110, 112, 114, 116) have a thickness about equal to the thickness of the nominal wall (i.e., the base portion 64). This is illustrated in FIGS. 4, 5, and 7.

According to the general rule discussed herein above, in order to avoid sink marks, the projections, i.e., the side walls 110, 112, 114, and 116, should have a thickness that is 50% to 60% of the thickness of the base portion 64. It will be appreciated, however, that the gas assisted injection molding technique used to construct the air bag door 40 allows avoidance of the general rule and permits the projections to have a thickness about equal to the thickness of the base portion 64 without producing sink marks. The prevention of sink marks helps provide an attractive aesthetic appearance for the class A surface 42. The thick projections are advantageous for several reasons.

In addition to providing support for the main wall 126 of the reinforcing portion 100, the side walls 110, 112, 114, and 116 serve as ribs for helping to reinforce the door 40. The side walls 110, 112, 114, and 116, having an increased thickness, are stronger than side walls constructed in accordance with the 50% to 60% general rule. This provides for a stronger and more robust construction of the air bag door 40. This also allows for a simpler construction since fewer reinforcing members, e.g., ribs, may be required to provide the required structural integrity.

The thicker side walls 110, 112, 114, and 116 provide a strong connection between the reinforcing portion 100 and the base portion 64. As a result, there is a strong connection between the bracket 62, the reinforcing portion 100, and the base portion 64. These strong connections allow the tether 44 (FIG. 1) to connect the air bag door 40 to the instrument panel 36 in a strong and reliable manner so as to help retain the door during deployment of the air bag 14.

The air bag door 40 constructed in accordance with the gas assisted injection molding technique of the present invention also helps simplify the construction of the door in comparison to prior art air bag doors. The molded portion 60 is molded around the bracket 62 in a single molding procedure to form the air bag door 40. This simple two-piece construction may thus provide benefits in terms of reduced material costs, manufacturing costs, and time savings.

In accordance with the preceding, it will be appreciated that the present invention also relates to an air bag door 40 and a method for producing the air bag door. The method includes the step of providing the mold 220, which includes the first mold piece 222 and the second mold pieces 224. The mold 220 has a closed condition in which a mold cavity 226 is defined between the first and second mold pieces 222 and 224. The method also includes the step of placing the metal bracket 62 in the mold cavity 226. The method also includes the steps of placing the mold 220 in the closed condition and injecting the hot melt into the mold cavity 226 to fill the mold cavity at least partially. The hot melt forms the molded portion 60 of the air bag door 40, which at least partially surrounds the bracket 62. The method further includes the step of injecting pressurized gas into the mold cavity 226. The pressurized gas pressurizes the chamber 170 and exerts a force on the main wall portion 126, the base portion 64, and the side walls 110, 112, 114, and 116 of the air bag door 40 while the hot melt cools. The method also includes the steps of cooling the hot melt to solidify the plastic material and releasing the pressurized gas from the chamber 170.

From the above description of the invention, those skilled in the art will perceive improvements, changes and modifications. For example, it will be appreciated that the air bag door construction of the present invention may be implemented to construct air bag doors other than the illustrated passenger side air bag door. These alternative air bag doors may include driver side air bag doors, and side impact air bag doors. Such improvements, changes and modifications within the skill of the art are intended to be covered by the appended claims.

Having described the invention, the following is claimed:

1. Apparatus for helping to protect an occupant of a vehicle, said apparatus comprising:
an inflatable vehicle occupant protection device inflatable from a stored position to an inflated position;
an inflation fluid source actuatable to provide inflation fluid for inflating said inflatable vehicle occupant protection device; and
a molded portion molded as a single piece of plastic material and associated with said inflatable vehicle occupant protection device;
said molded portion including a base portion and a reinforcing portion, said base portion having a first surface and a second surface opposite said first surface, said first surface forming a class A surface in the vehicle, said base portion having a first thickness measured between said first and second surfaces;
said reinforcing portion including a main wall portion spaced from said second surface and at least one side wall extending from said main wall portion to said second surface and merging with said second surface, said at least one side wall having a second thickness about equal to said first thickness, said main wall portion, said base portion, and said at least one side wall defining a chamber in said molded portion.

2. Apparatus as recited in claim 1, wherein said molded portion comprises a door for helping to enclose said inflatable vehicle occupant protection device in said stored position.

3. Apparatus as recited in claim 1, further comprising a bracket at least partially embedded in said molded portion; and
a tether secured to said bracket, said tether being for connecting said bracket and said molded portion to the vehicle.

4. Apparatus as recited in claim 1, wherein said chamber comprises means for receiving a pressurized gas during molding of said molded portion while said plastic material is in a molten condition, said pressurized gas exerting a force on said main wall portion, said base portion, and said at least one side wall during cooling of said plastic material.

5. Apparatus as recited in claim 4, wherein said pressurized gas when introduced into said chamber displaces and helps distribute said molten plastic material to help form said main wall portion, said base portion, and said at least one side wall.

6. Apparatus as recited in claim 3, wherein said bracket is at least partially embedded in said reinforcing portion of said molded portion, at least a portion of said bracket being positioned between first and second layers of said main wall portion, said first layer being presented toward said second surface in said chamber.

7. Apparatus as recited in claim 6, wherein said bracket includes connecting means for connecting said tether to said bracket, said connecting means extending through said second layer of said reinforcing portion.

8. Apparatus as recited in claim 1, wherein said at least one side wall comprises side walls extending from peripheral edges of said main wall portion to said second surface of said base portion and merging with said second surface, said chamber being defined by said main wall portion, said side walls, and a portion of said second surface bounded by said side walls.

9. Apparatus as recited in claim 8, wherein said main wall portion and said side walls define a main portion of said reinforcing portion, said reinforcing portion further comprising first and second rib portions extending transversely from said second surface of said base portion, said first rib portion merging with an upper side wall and a first end wall of said main portion and extending parallel to said first end wall, said second rib portion merging with said upper side wall and a second end wall of said main portion and extending parallel to said second end wall.

10. Apparatus as recited in claim 1, wherein said molded portion includes a rim portion extending transverse to said second surface of said base portion along a perimeter of said base portion, said molded portion further comprising a plurality of support portions for helping to support said door in the vehicle, each of said support portions comprising a main portion having an edge that merges with a terminal edge of said rim portion and extends transverse to said rim portion, each of said support portions further comprising a pair of legs merging with said main portion and diverging away from each other from opposite edges of said main portion to said second surface of said base portion, said main portion of each of said support portions including an aperture for receiving means for connecting said door to the vehicle.

11. Apparatus as recited in claim 1, wherein said pressurized gas exerts a force on said at least one side wall and said base portion to help prevent the formation of sink marks on said class A surface adjacent a location where said at least one side wall merges with said second surface.

12. Apparatus as recited in claim 1, wherein said pressurized gas comprises nitrogen.

13. Apparatus for helping to protect an occupant of a vehicle, said apparatus comprising:
an inflatable vehicle occupant protection device inflatable from a stored position to an inflated position;
an inflation fluid source actuatable to provide inflation fluid for inflating said inflatable vehicle occupant protection device; and
a door for helping to enclose said inflatable vehicle occupant protection device in said stored position, said door comprising:
a molded portion molded as a single piece of plastic material;
a bracket at least partially embedded in said molded portion; and
a tether secured to said bracket, said tether being for connecting said door to the vehicle;
said molded portion including a base portion and a reinforcing portion, said base portion having a first surface and a second surface opposite said first surface, said first surface forming a class A surface in the vehicle, said base portion having a first thickness measured between said first and second surfaces;
said reinforcing portion including a main wall portion spaced from said second surface and at least one side wall extending from said main wall portion to said second surface and merging with said second surface, said at least one side wall having a second thickness about equal to said first thickness, said main wall portion, said base portion, and said at least one side wall defining a chamber in said door.

14. Apparatus as recited in claim 13, wherein said chamber comprises means for receiving a pressurized gas during molding of said molded portion while said plastic material is in a molten condition, said pressurized gas exerting a force on said main wall portion, said base portion, and said at least one side wall during cooling of said plastic material.

15. Apparatus as recited in claim 14, wherein said pressurized gas when introduced into said chamber displaces and helps distribute said molten plastic material to help form said main wall portion, said base portion, and said at least one side wall.

16. Apparatus as recited in claim 13, wherein said bracket is at least partially embedded in said reinforcing portion of said molded portion, at least a portion of said bracket being positioned between first and second layers of said main wall portion, said first layer being presented toward said second surface in said chamber.

17. Apparatus as recited in claim 16, wherein said bracket includes connecting means for connecting said tether to said bracket, said connecting means extending through said second layer of said reinforcing portion.

18. Apparatus as recited in claim 13, wherein said at least one side wall comprises side walls extending from peripheral edges of said main wall portion to said second surface of said base portion and merging with said second surface, said chamber being defined by said main wall portion, said side walls, and a portion of said second surface bounded by said side walls.

19. Apparatus as recited in claim 18, wherein said main wall portion and said side walls define a main portion of said reinforcing portion, said reinforcing portion further comprising first and second rib portions extending transversely from said second surface of said base portion, said first rib portion merging with an upper side wall and a first end wall of said main portion and extending parallel to said first end wall, said second rib portion merging with said upper side wall and a second end wall of said main portion and extending parallel to said second end wall.

20. Apparatus as recited in claim 13, wherein said molded portion includes a rim portion extending transverse to said second surface of said base portion along a perimeter of said base portion, said molded portion further comprising a plurality of support portions for helping to support said door in the vehicle, each of said support portions comprising a main portion having an edge that merges with a terminal edge of said rim portion and extends transverse to said rim portion, each of said support portions further comprising a pair of legs merging with said main portion and diverging away from each other from opposite edges of said main portion to said second surface of said base portion, said main portion of each of said support portions including an aperture for receiving means for connecting said door to the vehicle.

21. Apparatus as recited in claim 13, wherein said pressurized gas exerts a force on said at least one side wall and said base portion to help prevent the formation of sink marks on said class A surface adjacent a location where said at least one side wall merges with said second surface.

22. Apparatus as recited in claim 13, wherein said pressurized gas comprises nitrogen.

23. An air bag door for helping to enclose an air bag in a stored position in a vehicle, said air bag door comprising:
a molded portion molded as a single piece of plastic material; and
a bracket embedded in said molded portion;
said molded portion comprising a base portion and a reinforcing portion, said base portion having a first surface and a second surface opposite said first surface, said first surface forming a class A surface in the vehicle, said base portion having a first thickness measured between said first and second surfaces;
said reinforcing portion including a main wall portion spaced from said second surface and at least one side wall extending from said main wall portion to said second surface and merging with said second surface, said at least one side wall having a second thickness about equal to said first thickness;
said main wall portion, said base portion, and said at least one side wall defining a chamber of said door, said chamber receiving a pressurized gas during molding of said molded portion while said plastic material is in a molten condition, said pressurized gas exerting a force on said main wall portion, said base portion, and said at least one side wall.

24. The air bag door as recited in claim 23, further comprising a tether for connecting said air bag door to the vehicle, said bracket including connecting means for connecting said tether to said bracket, said connecting means extending through said molded portion.

25. An air bag door for helping to enclose an air bag in a stored position in a vehicle, said air bag door comprising:
a molded portion molded as a single piece of plastic material; and
a metal bracket at least partially embedded in said molded portion, said bracket being connectable with a tether for securing said air bag door in the vehicle, said molded portion comprising:
a base portion having a first surface and a second surface opposite said first surface, said base portion having a first thickness measured between said first and second surfaces;
a bracket support portion, said bracket support portion at least partially surrounding said bracket; and
at least one side wall for reinforcing said air bag door and supporting said bracket support portion and said bracket spaced from said second surface;
said base portion, said bracket support portion, and said at least one side wall defining a chamber of said door, said chamber receiving a pressurized gas during molding of said door while said plastic material is in a molten condition.

26. A method for producing an air bag door for helping to enclose an air bag in a stored position in a vehicle, said method comprising the steps of:
providing a mold comprising a first mold piece and a second mold piece, said mold having a closed condition in which a mold cavity is defined between said first and second mold pieces;
placing a metal bracket in said mold cavity;
placing said mold in said closed condition;
injecting a molten plastic material into said mold cavity to fill said mold cavity at least partially, said molten plastic material forming a molded portion of said air bag door in said mold cavity that at least partially surrounds said bracket, said molded portion including a base portion having a first surface and a second surface opposite said first surface, said base portion having a first thickness measured between said first and second surfaces, said molded portion further including at least one side wall for reinforcing said air bag door and supporting said bracket, said at least one side wall extending transverse to said base portion and merging with said second surface, said at least one side wall having a second thickness about equal to said first thickness; and
injecting a pressurized gas into said mold cavity, said gas when injected into said mold cavity helping to form a chamber of said air bag door, said chamber being bounded by said at least one side wall, said second surface, and a portion of said molded portion overlying said bracket, said pressurized gas pressurizing said chamber and exerting a force on said main wall portion, said base portion, and said at least one side wall during cooling of said plastic material.

27. The method recited in claim 26, further comprising the steps of cooling said molten plastic material to solidify said plastic material and releasing said pressurized gas from said chamber.
